(19) United States
(12) Patent Application Publication
(10) Pub. No.: US 2022/0406100 A1
(43) Pub. Date: Dec. 22, 2022

(54) INFORMATION PROCESSING DEVICE, PROGRAM, AND INFORMATION PROCESSING METHOD

(71) Applicant: TOYOTA JIDOSHA KABUSHIKI KAISHA, Toyota-shi (JP)

(72) Inventors: Toyokazu NAKASHIMA, Kasugai-shi (JP); Ryuichi KAMAGA, Nisshin-shi (JP); Mitsuhiro MIURA, Okazaki-shi (JP); Yasuhiro BABA, Gifu-ken (JP); Tomokazu MAYA, Nagoya-shi (JP); Ryosuke KOBAYASHI, Nagakute-shi (JP); Genshi KUNO, Kasugai-shi (JP)

(73) Assignee: TOYOTA JIDOSHA KABUSHIKI KAISHA, Toyota-shi (JP)

(21) Appl. No.: 17/732,818

(22) Filed: Apr. 29, 2022

(30) Foreign Application Priority Data
Jun. 17, 2021 (JP) 2021-101114

(51) Int. Cl. G07C 5/02; G07C 5/00; H04W 4/02; H04W 4/40

(52) U.S. Cl. CPC G07C 5/02; G07C 5/008; H04W 4/025; H04W 4/40

(57) ABSTRACT

An information processing device that is able to communicate with a vehicle includes a control unit and a communication unit. The control unit executes: acquiring travel data of the vehicle via the communication unit; specifying, from the travel data, a location where the number of times the vehicle has stopped for a predetermined time or more is a predetermined number of times or more; and acquiring location-related information related to the location via the communication unit.

### CROSS-REFERENCE TO RELATED APPLICATION

This application claims priority to Japanese Patent Application No. 2021-101114 filed on Jun. 17, 2021, incorporated herein by reference in its entirety.

### BACKGROUND

### 1. Technical Field

The present disclosure relates to an information processing device, a program, and an information processing method.

### 2. Description of Related Art

Conventionally, there is known a technique for registering a current position as a specific point when a vehicle has stopped for a certain period of time or more for the first time after operating a reset switch of a navigation device (for example, Japanese Unexamined Patent Application Publication No. 08-210866 (JP 08-210866 A)).

### SUMMARY

In the above JP 08-210866 A, the specific point can be registered, but information related to the specific point cannot be acquired.

An object of the present disclosure made in view of such circumstances is to provide an information processing device, a program, and an information processing method capable of acquiring information related to a specific location regarding a user of a vehicle.

An information processing device according to one embodiment of the present disclosure is an information processing device that is able to communicate with a vehicle and includes a control unit and a communication unit.

The control unit executes:
acquiring travel data of the vehicle via the communication unit;
specifying, from the travel data, a location where the number of times the vehicle has stopped for a predetermined time or more is a predetermined number of times or more; and
acquiring location-related information related to the location via the communication unit.

A program according to the one embodiment of the present disclosure causes
a computer serving as an information processing device that is able to communicate with a vehicle to execute:
acquiring travel data of the vehicle;
specifying, from the travel data, a location where the number of times the vehicle has stopped for a predetermined time or more is a predetermined number of times or more; and acquiring location-related information related to the location.

An information processing method according to the one embodiment of the present disclosure is
an information processing method executed by an information processing device that is able to communicate with a vehicle, the information processing method including:
acquiring travel data of the vehicle;
specifying, from the travel data, a location where the number of times the vehicle has stopped for a predetermined time or more is a predetermined number of times or more; and acquiring location-related information related to the location.

With the information processing device, the program, and the information processing method according to the one embodiment of the present disclosure, it is possible to acquire information related to a specific location regarding the user of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an information processing system;

FIG. 2 is a block diagram showing a configuration of an information processing device;

FIG. 3 is a block diagram showing a configuration of a vehicle;

FIG. 4 is a block diagram showing a configuration of a user terminal;

FIG. 5 is a diagram showing a data structure of a travel data database (DB);

FIG. 6 is a diagram showing a data structure of a location-related information DB; and

FIG. 7 is a flowchart showing operations of the information processing device.

### DETAILED DESCRIPTION OF EMBODIMENTS

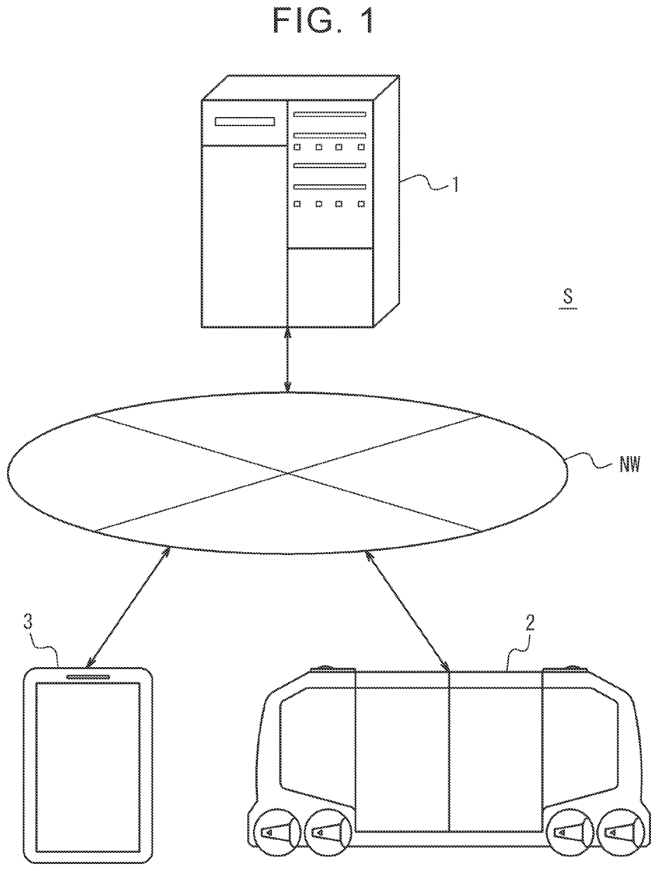

FIG. 1 is a schematic diagram of an information processing system S according to the present embodiment. The information processing system S includes an information processing device 1, a vehicle 2, and a user terminal 3 that can communicate with each other via a network NW. The network NW includes, for example, a mobile communication network and the Internet.

In FIG. 1, for convenience of description, one information processing device 1, one vehicle 2, and one user terminal 3 are illustrated. However, the numbers of the information processing devices 1, the vehicles 2, and the user terminals 3 are not limited to the above. For example, the processes executed by the information processing device 1 according to the present embodiment may be executed by a plurality of the information processing devices 1 disposed in a distributed manner. A plurality of the user terminals 3 may be operated by a user.

The outline of the processes executed by the information processing device 1 according to the present embodiment will be described. A control unit 11 of the information processing device 1 acquires travel data of the vehicle 2 via a communication unit 12, specifies a location where the number of times the vehicle 2 has stopped for a predetermined time or more is a predetermined number of times or more from the travel data, and acquires location-related information related to the specified location via the communication unit 12 With this configuration, for example, when the user of the vehicle 2 is out of contact, the information processing device 1 can specify a location frequently visited by the user of the vehicle 2 in the past and acquire information related to the specified location. Therefore, the information processing device 1 can acquire the information on a location related to the user of the vehicle 2, which is not limited to the home where the user of the vehicle 2 lives most recently, so that it is possible to support tracing of the user of the vehicle 2.

The information processing device 1 is installed in facilities such as a data center. The information processing device 1 is, for example, a computer such as a server belonging to a cloud computing system or other computing systems. As an alternative example, the information processing device 1 may be mounted on the vehicle 2.

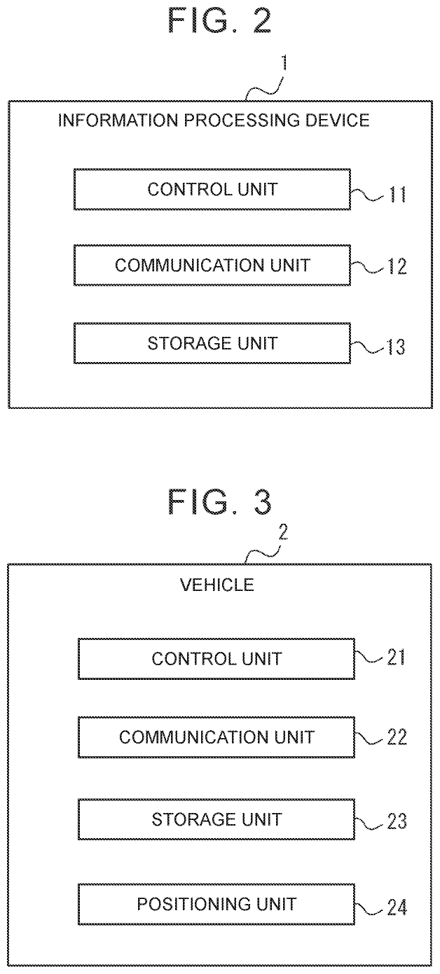

The internal configuration of the information processing device 1 will be described in detail with reference to FIG. 2.

The information processing device 1 includes the control unit 11, the communication unit 12, and a storage unit 13. The constituent components of the information processing device 1 are connected so as to be able to communicate with each other via a dedicated line, for example.

The control unit 11 includes, for example, one or more general-purpose processors including a central processing unit (CPU) or a micro processing unit (MPU). The control unit 11 may include one or more dedicated processors specialized for a specific process. The control unit 11 may include one or more dedicated circuits instead of including the processor. The dedicated circuit may be, for example, a field-programmable gate array (FPGA) or an application-specific integrated circuit (ASIC). The control unit 11 may include an electronic control unit (ECU). The control unit 11 transmits and receives information via the communication unit 12.

The communication unit 12 includes a communication module conforming to one or more wired or wireless local area network (LAN) standards for connecting to the network NW. The communication unit 12 may include a module conforming to one or more mobile communication standards such as the long term evolution (LTE), the fourth generation (4G), or the fifth generation (5G). The communication unit 12 may include a communication module and the like conforming to one or more short-range communication standards or specifications including Bluetooth (registered trademark), Air Drop (registered trademark), infrared data association (IrDA), ZigBee (registered trademark), FeliCa (registered trademark), or radio frequency identifier (RFID). The communication unit 12 transmits and receives information via the network NW.

The storage unit 13 includes a semiconductor memory, a magnetic memory, an optical memory, or a combination of at least two of them. However, the disclosure is not limited to this. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read-only memory (EEPROM). The storage unit 13 may function as, for example, a main storage device, an auxiliary storage device, or a cache memory. The storage unit 13 may store information on the result of analysis or processing by the control unit 11. The storage unit 13 may store various kinds of information and the like related to the operation or control of the information processing device 1. The storage unit 13 may store a system program, an application program, embedded software, and the like. The storage unit 13 includes a travel data DB and a location-related information DB described below.

The vehicle 2 includes any type of vehicles, such as a micromobility, a gasoline vehicle, a diesel vehicle, an HEV, a PHEV, a BEV, or an FCEV. The constituent components of the vehicle 2 are connected so as to be able to communicate with each other through an in-vehicle network such as controller area network (CAN) or a dedicated line, for example. The term “HEV” is an abbreviation for “hybrid electric vehicle”. The term “PHEV” is an abbreviation for “plug-in hybrid electric vehicle”. The term “BEV” is an abbreviation for “battery electric vehicle”. The term “FCEV” is an abbreviation for “fuel cell electric vehicle”. The vehicle 2 according to the present embodiment is driven by a driver. As an alternative example, the vehicle 2 may be autonomously driven at any level. The level of autonomous driving is, for example, one of levels 1 to 5 in the SAE leveling, for example. The term “SAE” is an abbreviation for the “Society of Automotive Engineers”. The vehicle 2 may be a MaaS dedicated vehicle. The term “MaaS” is an abbreviation for “mobility as a service”. The vehicle 2 may be, for example, a bicycle, a motorized bicycle, or a motorcycle.

The internal configuration of the vehicle 2 will be described in detail with reference to FIG. 3.

The vehicle 2 includes a control unit 21, a communication unit 22, a storage unit 23, and a positioning unit 24. The constituent components of the vehicle 2 are connected so as to be able to communicate with each other via, for example, a dedicated line.

The hardware configurations of the control unit 21, the communication unit 22, and the storage unit 23 of the vehicle 2 may be the same as the hardware configurations of the control unit 11, the communication unit 12, and the storage unit 13 of the information processing device 1, respectively. The description here is omitted.

The positioning unit 24 includes at least one GNSS receiver. The term “GNSS” is an abbreviation for “global navigation satellite system”. The GNSS includes, for example, at least one of GPS, QZSS, BeiDou, GLONASS, and Galileo. The term “GPS” is an abbreviation for “global positioning system”. The term “QZSS” is an abbreviation for “quasi-zenith satellite system”. The satellites of the QZSS are referred to as quasi-zenith satellites. The term “GLONASS” is an abbreviation for “global navigation satellite system”. The positioning unit 24 measures the position of the vehicle 2. The measurement result is acquired by the control unit 21 as the position information of the vehicle 2. The “position information” is information that can specify the position of the vehicle 2. The position information includes, for example, an address, latitude, longitude, or altitude. The position information is stored in association with time information.

The user terminal 3 is a terminal operated by the user. The user terminal 3 is, for example, a mobile device such as a mobile phone, a smartphone, a wearable device, or a tablet. As an alternative example, the user terminal 3 may be a general-purpose device such as a PC, or a dedicated device. The term “PC” is an abbreviation for “personal computer”.

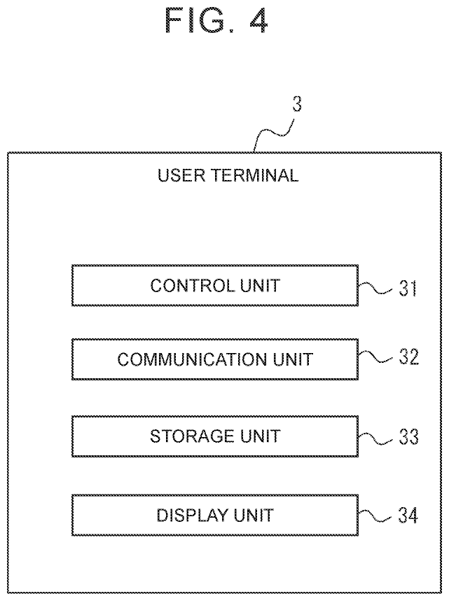

The internal configuration of the user terminal 3 will be described in detail with reference to FIG. 4.

The user terminal 3 includes a control unit 31, a communication unit 32, a storage unit 33, and a display unit 34. The constituent components of the user terminal 3 are connected so as to be able to communicate with each other via, for example, a dedicated line.

The hardware configurations of the control unit 31, the communication unit 32, and the storage unit 33 of the user terminal 3 may be the same as the hardware configurations of the control unit 11, the communication unit 12, and the storage unit 13 of the information processing device 1, respectively. The description here is omitted.

The display unit 34 is, for example, a display. The display is, for example, an LCD or an organic EL display. The term “LCD” is an abbreviation for “liquid crystal display”. The term “EL” is an abbreviation for “electroluminescence”. The display unit 34 displays information obtained through the operation of the user terminal 3. The display unit 34 may be connected to the user terminal 3 as an external output device instead of being provided in the user terminal 3. As a connection method, for example, any method such as a universal serial bus (USB), a high-definition multimedia interface (HDMI) (registered trademark), or Bluetooth (registered trademark) can be used. The display unit 34 can display, for example, at least one of family register-related information and the location-related information received from the information processing device 1.

Hereinafter, the processes executed by the information processing system S according to the present embodiment will be described in detail. Here, a case in which a user U01 of the user terminal 3 wishes to contact a user U02 who is an acquaintance or a friend but cannot contact the user U02 will be described. That is, the user U02 is out of contact. The user U02 used the vehicle 2 before the user U02 is out of contact. However, at present, the user U02 is not using the vehicle 2.

When the control unit 11 of the information processing device 1 receives a travel data acquisition request from the user terminal 3, the control unit 11 acquires travel data of the vehicle 2 from the storage unit 13. As an alternative example, when the control unit 11 receives the travel data acquisition request from the user terminal 3, the control unit 11 may acquire the travel data from the vehicle 2.

The storage unit 13 stores a user identification (ID) that identifies the user of the vehicle, travel data of the vehicle, and a location specified from the travel data in association with a vehicle ID. The travel data includes information indicating where and for how long the vehicle 2 has stopped. The term “stop” may indicate parking of the vehicle or a stop other than the parking of the vehicle. The travel data may be all data in the past or may be specified data during a past predetermined period.

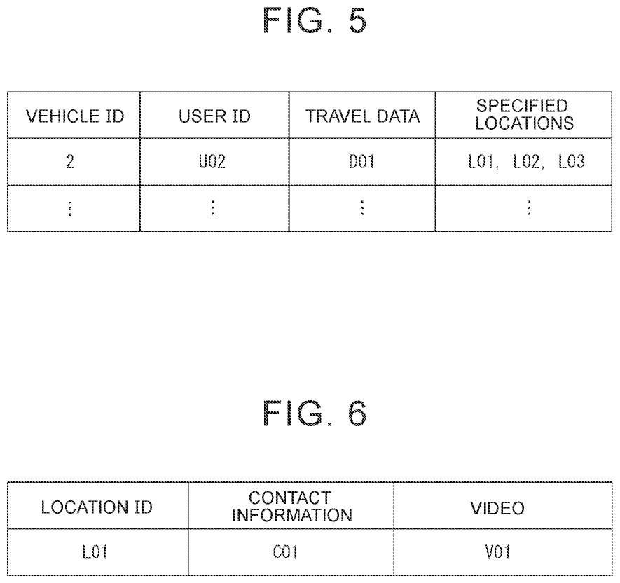

The control unit 11 specifies, from the travel data, a location where the number of times the vehicle 2 has stopped for a predetermined time or more is a predetermined number of times or more. The specified location is not limited to the home of the user U02 of the vehicle 2. The number of the specified locations is one or more. As shown in FIG. 5, the locations specified based on travel data DO1 here are LO1, L02, and L03. The predetermined time and the predetermined number of times may be set and changed as appropriate.

The control unit 11 acquires location-related information from the storage unit 13 for each of the specified locations. As shown in FIG. 6, the storage unit 13 stores contact information and video information in association with a location ID that identifies a location. The location-related information here includes at least one kind of the following information associated with the specified location LO1.
Contact information CO1 of the specified location (telephone number, email address, address, etc.)
Video V01 captured at the specified location (moving images, still images, etc.)

As an alternative example, the location-related information may be obtained from any storage device via the network NW.

The control unit 11 may transmit the location-related information to the user terminal 3. The user terminal 3 displays the location-related information on the display unit 34. The user U01 of the user terminal 3 traces the user U02 who is out of contact with reference to the location-related information.

The control unit 11 can acquire history of the location where the user U02 of the vehicle 2 has lived in the past from, for example, a server managed by the municipality.

The control unit 11 can estimate the municipality in which the user U02 has lived in the past, regardless of whether the control unit 11 can acquire the history of the location where the user U02 of the vehicle 2 has lived in the past. For example, when the control unit 11 detects the same municipality to which a plurality of locations among the locations specified from the travel data belongs, the detected municipality is estimated as the municipality in which the user U02 has lived in the past. The control unit 11 requests the family register-related information of the user U02 to the server of the detected municipality. The family register-related information includes, for example, at least one kind of information on certified copy of family register and information on certified copy of closed family register.

The information on certified copy of family register includes, for example, at least one kind of the following information.
Registered domicile
Name
Date of birth
Birth matters
Marriage matters

The information on certified copy of closed family register includes, for example, at least one kind of the following information.
Date and time when a person recorded in the family register was removed
Reason why a person recorded in the family register was removed (for example, death or transfer of registered domicile)

The control unit 11 may transmit the family register-related information to the user terminal 3. The user terminal 3 displays the family register-related information on the display unit 34. The user U01 of the user terminal 3 traces the user U02 who is out of contact with reference to the family register-related information.

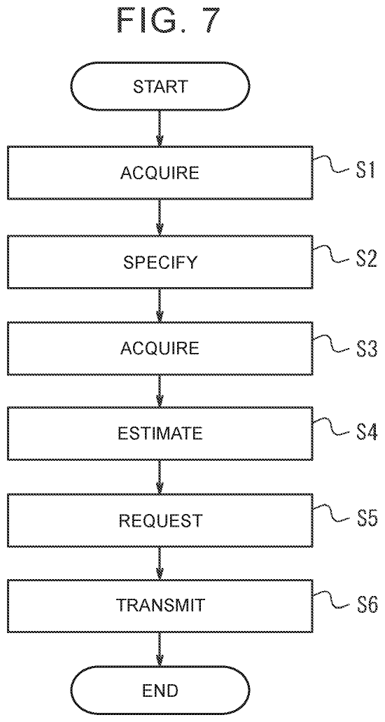

An information processing method executed by the information processing device 1 according to the present embodiment will be described with reference to FIG. 7.

In step S1, the control unit 11 acquires the travel data of the vehicle 2 from the storage unit 13. The control unit 11 may periodically acquire the travel data, or may acquire the travel data when the acquisition request is received from the user terminal 3.

In step S2, the control unit 11 specifies, from the acquired travel data, a location where the number of times the vehicle 2 has stopped for a predetermined time or more is a predetermined number of times or more.

In step S3, the control unit 11 acquires the location-related information related to the specified location from the storage unit 13.

In step S4, when the control unit 11 detects the same municipality to which a plurality of locations among the specified locations belongs, the detected municipality is estimated as the municipality in which the user U02 of the vehicle 2 has lived in the past.

In step S5, the control unit 11 requests the server of the municipality estimated in step S4 to transmit the family register-related information of the user U02.

In step S6, the control unit 11 transmits the location-related information and the family register-related information to the user terminal 3. As an alternative example, a timing of transmitting the location-related information may be any timing after step S3 instead of step S6.

As an alternative example, execution of steps S4 to S6 is optional.

According to the present embodiment as described above, the control unit 11 acquires the travel data of the vehicle 2 via the communication unit 12, specifies a location where the number of times the vehicle 2 has stopped for a predetermined time or more is a predetermined number of times or more from the travel data, and acquires the location-related information related to the specified location via the communication unit 12. With this configuration, for example, when the user U02 of the vehicle 2 is out of contact, the information processing device 1 can specify a location frequently visited by the user U02 of the vehicle 2 in the past and acquire information related to the specified location. Therefore, the information processing device 1 can acquire the information on a location related to the user U02 of the vehicle 2, which is not limited to the home where the user U02 of the vehicle 2 lives most recently, so that it is possible to support tracing of the user U02 of the vehicle 2.

Further, according to the present embodiment, the location-related information includes the contact information of the location. The location-related information also includes a video captured at the location. With this configuration, the information processing device 1 can support tracing of the user U02 of the vehicle 2.

Further, according to the present embodiment, when the control unit 11 detects the same municipality to which a plurality of locations among the specified locations belongs, the same municipality is estimated as the municipality in which the user U02 of the vehicle 2 has lived in the past. The control unit 11 requests the family register-related information of the user U02 to the server of the municipality. The family register-related information includes, for example, at least one kind of information on certified copy of family register and information on certified copy of closed family register. With this configuration, the information processing device 1 can estimate the municipality in which the user U02 has lived in the past, so that it is possible to further support tracing of the user U02.

Although the present disclosure has been described above based on the drawings and the embodiment, it should be noted that those skilled in the art may make various modifications and alterations thereto based on the present disclosure. Other changes may be made without departing from the scope of the present disclosure. For example, the functions included in each means or step can be rearranged so as not to be logically inconsistent, and a plurality of means or steps can be combined into one or divided.

For example, in the above embodiment, a program that executes all or part of the functions or processes of the information processing device 1 can be recorded in a computer-readable recording medium. The computer-readable recording medium includes a non-transitory computer-readable medium such as a magnetic recording device, an optical disc, a magneto-optical recording medium, or a semiconductor memory. The distribution of the program is carried out, for example, by selling, transferring, or renting a portable recording medium such as a digital versatile disc (DVD) or a compact disc read-only memory (CD-ROM) on which the program is recorded. Further, the distribution of the program may be performed by storing the program in a storage of a server and transmitting the program from the server to another computer. Further, the program may be provided as a program product. The present disclosure can also be realized as a program that can be executed by a processor.

The computer temporarily stores the program recorded in the portable recording medium or the program transferred from the server in the main storage device, for example. The computer then causes the processor to read the program stored in the main storage device, and causes the processor to execute processes in accordance with the read program. The computer may read the program directly from the portable recording medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the process of the computer corresponds to the “data equivalent to a program”.

What is claimed is:

1. An information processing device that is able to communicate with a vehicle and includes a control unit and a communication unit, wherein the control unit executes:
acquiring travel data of the vehicle via the communication unit;
specifying, from the travel data, a location where the number of times the vehicle has stopped for a predetermined time or more is a predetermined number of times or more; and
acquiring location-related information related to the location via the communication unit.

2. The information processing device according to claim 1, wherein the location-related information includes contact information of the location.

3. The information processing device according to claim 1, wherein the location-related information includes a video captured at the location.

4. The information processing device according to claim 1, wherein the control unit estimates a municipality in which a user of the vehicle has lived in a past.

5. The information processing device according to claim 4, wherein when the control unit detects the same municipality to which a plurality of locations among a plurality of the specified locations belongs, the same municipality is estimated as the municipality in which the user of the vehicle has lived in the past.

6. The information processing device according to claim 5, wherein the control unit requests family register-related information of the user to a server of the municipality.

7. The information processing device according to claim 6, wherein the family register-related information includes at least one kind of information on certified copy of family register and information on certified copy of closed family register.

8. A program that causes a computer serving as an information processing device that is able to communicate with a vehicle to execute:
acquiring travel data of the vehicle;
specifying, from the travel data, a location where the number of times the vehicle has stopped for a predetermined time or more is a predetermined number of times or more; and
acquiring location-related information related to the location.

9. The program according to claim 8, wherein the location-related information includes contact information of the location.

10. The program according to claim 8, wherein the location-related information includes a video captured at the location.

11. The program according to claim 8, the program causing the computer to execute estimating a municipality in which a user of the vehicle has lived in a past.

12. The program according to claim 11, the program causing the computer to execute, when detecting the same municipality to which a plurality of locations among a plurality of the specified locations belongs, estimating the same municipality as the municipality in which the user of the vehicle has lived in the past.

13. The program according to claim 12, the program causing the computer to execute requesting family register-related information of the user to a server of the municipality.

14. The program according to claim 13, wherein the family register-related information includes at least one kind of information on certified copy of family register and information on certified copy of closed family register.

15. An information processing method executed by an information processing device that is able to communicate with a vehicle, the information processing method comprising:
acquiring travel data of the vehicle;
specifying, from the travel data, a location where the number of times the vehicle has stopped for a predetermined time or more is a predetermined number of times or more; and
acquiring location-related information related to the location.

16. The information processing method according to claim 15, wherein the location-related information includes contact information of the location.

17. The information processing method according to claim 15, wherein the location-related information includes a video captured at the location.

18. The information processing method according to claim 15, further comprising estimating a municipality in which a user of the vehicle has lived in a past.

19. The information processing method according to claim 18, comprising, when detecting the same municipality to which a plurality of locations among a plurality of the specified locations belongs, estimating the same municipality as the municipality in which the user of the vehicle has lived in the past.

20. The information processing method according to claim 19, comprising requesting family register-related information of the user to a server of the municipality.
